(19) United States
(12) Patent Application Publication
(10) Pub. No.: US 2010/0215298 A1
(43) Pub. Date: Aug. 26, 2010

(54) CAGE SEGMENT OF A PLASTIC CAGE AND ROLLER BEARING COMPRISING SAID PLASTIC CAGE

(75) Inventor: Rudolf Zeidlhack, Werneck (DE)

Correspondence Address: LUCAS & MERCANTI, LLP, 475 Park Avenue South, New York, NY, 10016, US

(73) Assignee: Schaeffler Technologies GmbH & Co. KG, Herzogenaurach (DE)

(21) Appl. No.: 12/682,173

(22) PCT Filed: Oct. 7, 2008
(86) PCT No.: PCT/DE2008/001653

§ 371 Date: Apr. 13, 2010

(30) Foreign Application Priority Data
Oct. 10, 2007 (DE) 10 2007 048 655.5

(51) Int. Cl. F16C 19/24

(52) U.S. Cl. 384/51

(57) ABSTRACT

A cage segment of a plastic cage for a roller bearing, especially a large-diameter roller bearing. A plurality of the cage segments are arranged, or are to be arranged, in such a way that they butt adjacently or against each other on the front side in the peripheral direction. The cage segments include a pocket for a rolling body and a connecting device embodied in such a way that the cage segments can be interconnected in the form of chains.

### FIELD OF THE INVENTION

The invention relates to a cage segment of a plastic cage for a roller bearing, in particular for a large-diameter roller bearing, wherein a plurality of such cage segments are arranged and/or are to be arranged abutting against one another at their ends in the circumferential direction in order to form the plastic cage, and wherein the cage segment has at least one pocket for a roller body, and to a roller bearing comprising a plastic cage with such cage segments.

Roller bearings of known designs usually comprise an internal ring, an external ring, a plurality of roller bodies, which are rotatably mounted between the internal ring and external ring, and, optionally, a cage for guiding the roller bodies. The cage ensures here that the roller bodies do not abut against one another, but are instead guided at a predefined distance from one another.

In particular in the case of large-diameter roller bearings, that is to say roller bearings comprising an external diameter or pitch diameter of, for example, greater than 500 mm, it becomes necessary for the roller bodies which are of correspondingly heavy design to be guided reliably by means of a cage.

A possible embodiment of a cage of a large-diameter roller bearing made of metal is disclosed, for example, in patent application publication DE 155 74 80 A1 which presents a roller bearing cage comprising two end rings which are spaced apart from one another in the axial direction and have aligned holes which are distributed over the circumference and have the purpose of holding end pins of webs in a rotationally fixed fashion, wherein the webs form, together with the end rings, pockets for the roller bodies.

As an alternative to cages made of metal, plastic cages are known which are manufactured in one piece, in particular, in the case of small-diameter roller bearings, but in the case of large-diameter roller bearings they are also composed of a plurality of cage segments.

Such a plastic cage is described, for example, in patent application publication DE 102 46 825 A1, which probably forms the closest prior art. The plastic cage is formed from a plurality of plastic cage segments which, in the installed state, abut against one another at their ends, wherein, when the cage segments of the plastic cage are arranged in a gap-free sequence, an intermediate space remains between the adjacent end sides of a last segment and of a first segment, wherein the average extent of this intermediate space in the circumferential direction has, at room temperature, a value between 0.15% and 1% of the total circumference of a circle which runs centrally through the segments which are arranged in a sequence.

A prior art document which was published after the priority date of the present document is German patent application DE 10 2006 0229 51.7 by the applicant.

The invention is based on the object of proposing a cage segment for a plastic cage which exhibits an improved functional behavior compared to the known solutions.

For this purpose, a plastic cage segment having the features of claim 1 and a roller bearing having a plastic cage which is formed from a plurality of such plastic segments and has the features of claim 18 is proposed. Preferred or advantageous embodiments of the invention result from the subclaims, the following description and the appended figures.

According to the invention, a cage segment of a plastic cage for a roller bearing is disclosed, wherein the cage segment is designed and/or suitable for use in a large-diameter roller bearing. The large-diameter roller bearing preferably has a pitch diameter of more than 500 mm, in particular more than 1000 mm. The roller bearing is used, in particular, for supporting the rotor in a wind power plant.

The cage segment is embodied in such a way that, in order to form the plastic cage, a plurality of cage segments are arranged and/or are to be arranged adjoining and/or abutting one another at their ends in the circumferential direction. In this context, plastic segments and bearing rings of the roller bearing are matched to one another in such a way that the plastic segments do not bear against one another under compressive loading, but rather instead an intermediate space remains between the cage segments, between the end sides of the cage segments.

In order to guide the roller bearings, the cage segment has at least one pocket, preferably a plurality of pockets for, in each case, at least one roller body.

Within the scope of the invention, it is proposed that the cage segment has a connecting device which is integrally connected, in particular from a single material, to the cage section and which is embodied in such a way that cage segments of the same type can be coupled to one another in the manner of a chain in order to form the plastic cage. The connecting device is preferably structurally implemented here in such a way that the connection can disengage when a limiting force is exceeded and can also engage or latch again.

An advantage of the connectable cage segment over loosely inserted plastic cage segments, such as are known from the prior art, is that the loosely inserted plastic segments have to have overall final play which has to be designed to compensate expansion of all the plastic cage segments of the plastic cage, such as can occur owing to temperature and/or swelling. In the most unfavorable case, when the plastic cage segments are loosely inserted, it is thus possible for a gap to form between two segments at a location which corresponds to the overall end play. This gap can lead to an increase in the friction at the roller bodies, which results in a higher roller bearing temperature and wear on the contact faces of the roller bearing.

In contrast, the connecting device ensures that individual cage segments cannot be spaced apart too far from one another, with the result that the described, negative effect is prevented.

In one particularly preferred embodiment of the invention, the connecting device is embodied in such a way that a limited play is made possible in the circumferential direction between two cage segments which abut against one another. The limited play, or the fitting with play, permits an intermediate space to be produced between the end sides of the plastic cage segments which adjoin or abut one another at their ends.

The limited play is particularly preferably implemented with a magnitude which is in the range of the maximum thermal expansion and/or swelling expansion of one of the cage segments under normal operating conditions. Under the normal operating conditions, temperatures between, for example, 20° C. and 80° C., but less than 150° C., are preferably expected.

The limited play preferably has a magnitude of 0.2% to 2%, in particular 0.5% to 1.5%, and especially 1% of the circumferential length of the cage segment, that is to say of an individual cage segment. The circumferential length is preferably measured as a circular length between the two end sides of the cage segment at the level of the pitch diameter of the inserted roller bodies. Two cage segments are thus connected via the connecting device in such a way that between them there is still the necessary play which is required for the swelling and for the larger degree of expansion of an individual cage segment compared to the other bearing components with other materials, in particular the bearing rings and the roller bodies. In this context, it is preferred for the limited play to be made equal to or only minimally larger than the possible overall expansion of the plastic cage in the direction of rotation.

In one preferred structural implementation, the cage segment has transverse webs and side ring sections, wherein the transverse webs connect the side ring sections in one piece and/or from one material, with the result that the intermediate space between the transverse webs forms at least one or more pockets for the roller bearing or bearings.

In one preferred structural embodiment, the side bands and/or the transverse webs are matched in the radial extent with respect to the rotational axis of the roller bearing in such a way that there remains a large free space through which lubricant can be fed to the roller bearing or the roller bodies. In particular, the side ring sections and/or the transverse webs are arranged overlapping the pitch diameter of the roller bearings in the radial direction and cover approximately one-third of the diameter of the roller body.

In order to improve the lubrication of the roller bodies, in one preferred development of the invention the transverse webs are embodied in such a way that only certain sections, in particular only the end regions, of the roller bodies come to bear in their longitudinal direction against the transverse webs. The transverse webs are, in particular, embodied in such a way that a central part of the roller bearings runs without contact with respect to the transverse webs.

In one preferred structural implementation, the transverse webs are embodied with a reduced diameter and/or wasted in the central part in the circumferential direction of the plastic cage. This embodiment has the advantage that, in the central part of the roller bodies, the transverse web is not in contact with the roller body, and therefore also no lubricant is wiped off.

In order to connect the cage segments to one another, the connecting device comprises clips which are arranged offset in the axial direction on both sides of the side ring sections, are integrally formed on the side ring sections and engage axially around the outside of a further cage segment which is to be connected. In the axial plan view, the clips are embodied so as be congruent or as an extension of the side ring sections, in particular said clips have the same radial extent as the side ring sections. The free ends of the formed-on clips are of elastic design and permit sprung resilience in the axial direction. In order to connect the clip to a following cage segment, the clip has a securing nose which is directed axially with respect to the internal region of the cage segment.

Furthermore, the connecting device comprises opposing securing noses which are arranged on the axial external side of the cage segment. Particularly preferably, the clips with the securing noses are arranged on one side of the cage segment and the opposing securing clips are arranged on the other side of the cage segment, with the result that when the cage segments are arranged in a chain, clips respectively engage in opposing securing noses or engage over them. However, in alternative embodiments, a clip and an opposing securing nose can be arranged on each side in the circumferential direction of the cage segment. When assembly takes place, the securing noses of a first cage segment hook together with the opposing securing noses of a second cage segment in order to form the plastic cage. Here, the clips are deflected axially, with the result that the securing noses can slide over the opposing securing noses and hook behind the opposing securing noses. The hooking connection is preferably embodied in such a way that it can be released without destruction by means of a tensile force in the circumferential direction when a specific limiting force is reached. In return, released cage segments can close again automatically when a compressive force is applied in the direction of rotation. This embodiment has the advantage that when the roller bearing or the plastic cage is briefly overloaded, the cage segments can disengage from one another without destruction and can connect to one another again when a normal operating state is reached, with the result that the plastic cage is embodied in a “self-repairing” fashion.

In one particularly preferred implementation, at least one sliding shoe is formed on at least one of the transverse webs, preferably on a plurality of transverse webs, in particular on all the transverse webs, which sliding shoe is designed for the sliding support of the cage segment on a bearing ring, in particular an external ring of the roller bearing. In one preferred implementation, two sliding shoes, which are arranged spaced apart from one another in the axial direction, are formed on at least one transverse web. In particular, the sliding shoes are positioned in such a way that they are arranged in the edge region of the pocket which is formed by the transverse webs. Considered in functional terms, the sliding shoes are arranged axially on the outside of a compression ellipse which is formed by the roller bodies and the bearing ring in the normal operating mode. This embodiment has the advantage that the inflow of lubricant to the region of the roller body which is subjected to compressive loading is not disrupted by the sliding shoe or shoes, or only disrupted to a minimum degree.

In one preferred structural implementation, the sliding shoe is embodied, in an axial plan view, in the form of a filled funnel or of a mushroom and/or defines, on the radial outer side, a continuous bearing face which is curved in cross section in the perpendicular direction with respect to the rotational axis and is preferably curved without a turning point. The bearing face has a preferably constant or at least continuous curvature radius profile which is embodied in the same direction or always the same direction with respect to the curvature radius of the bearing ring, but exhibits a smaller curvature radius. For example, the bearing face has a curvature radius which is less than 50%, preferably less than 30% and in particular less than 10% of the curvature radius of the raceway of the bearing ring. The reduced curvature radius has the advantage that the sliding shoe bears on the bearing ring in a runner-like fashion with only a central part of the sliding shoe, with the result that during operation in the circumferential direction lubricant can be pushed between the sliding shoe and the ring through the edge regions of the sliding shoe.

In one preferred development of the invention, the side face, facing an adjacent roller body, of the sliding shoe is embodied as a guide face for the roller body. Optionally, the curvature radius of the guide face corresponds at least in certain sections to the roller body radius or is embodied so as to be up to 10% larger and/or closely fitting.

The guidance of the cage segments between the raceway of an external ring and in the internal direction is preferably carried out via the roller bodies. In particular, the cage segment is embodiment in such a way that the funnel-shaped sliding shoes are wrapped around the rolling body at least in a section in the radially outer direction with respect to the pitch diameter.

In one preferred development of the invention, the cage segment has guide knobs which are directed radially inward and which are designed to support the cage segment on a further ring, in particular on an internal ring. The guide knobs are preferably spaced apart from one another in the axial direction in a similar way to the sliding shoes. It is also preferably provided that only every second or every n-th transverse web is fitted with such guide knobs, with the result that transverse webs without guide knobs may also be provided.

In order to reduce the friction further, the guide knobs have, at their free end, features which reduce the sliding friction, in particular rounded portions. The guide knobs which are directed inward are configured in their length in such a way that they ensure additional support of the plastic cage or of the cage segment only in special cases. Such special cases occur, for example, when the plastic cage is deformed as a result of particularly high forces or after a certain degree of wear of the guiding inner side of the sliding shoes. Overall, guide webs, which are embodied as runners in the circumferential direction, are arranged on the cage segments in the outward direction toward the external ring raceway, and said guide webs ensure virtual optimum sliding in the bearing raceway on a film of lubricant. The guide knobs or spacing webs are satisfactorily rounded facing inwards toward the internal ring raceway in order to provide good sliding properties when contact occurs.

The cage segment is preferably manufactured in an injection-molding method, wherein the material used is, for example, a thermoplastic, in particular with a glass/carbon-aramid reinforcement, in particular poly-ether-ether-ketone with a fiber content between 10 to 50% by weight. In order to improve the injection-molding conditions, the side ring sections and the transverse webs of the cage segment as well as the guide knobs and the sliding shoes each have the same web cross sections.

A further subject matter relates to a roller bearing comprising a plastic cage having the features of claim 18, wherein the plastic cage is formed from a plurality of the cage segments as claimed in one of the preceding claims. The roller bearing is preferably embodied as a play-free and/or pre-stressed roller bearing, in particular for rotors of wind power plants, in particular the roller bearing is a two-row tapered roller bearing, preferably with a large compression angle in a range of, for example, 45°.

The cage segments are guided, on the one hand, by means of the support via the sliding shoes on the external ring and, on the other hand, via the bearing of the guide faces against the roller bodies or via the guide knobs.

Further features, advantages and effects of the invention emerge from the following description of a preferred exemplary embodiment of the invention, in which:

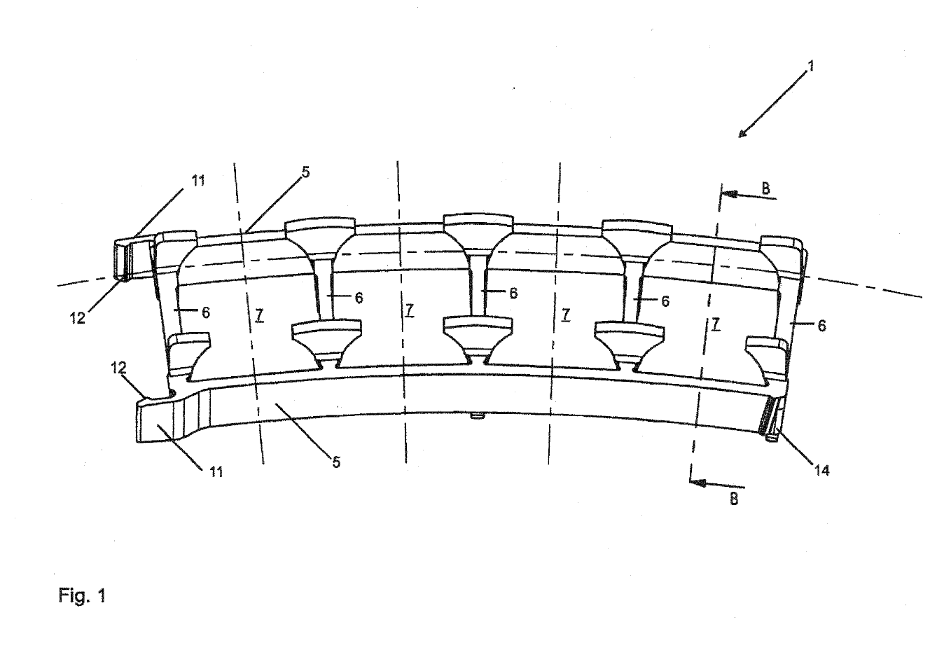

FIG. 1 shows a schematic, three-dimensional plan view of a cage segment as an exemplary embodiment of the invention;

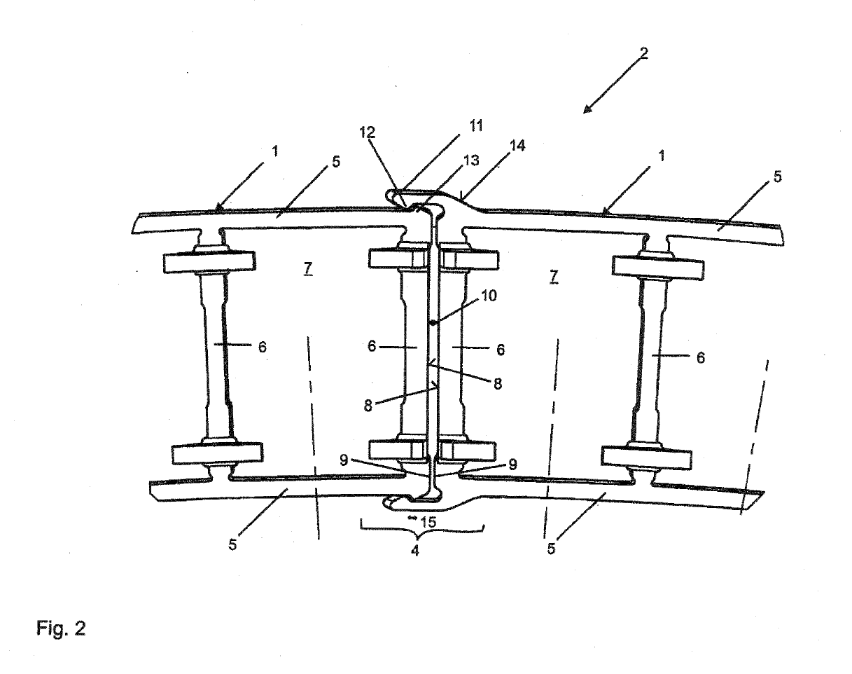

FIG. 2 shows a schematic, three-dimensional plan view from radially outside onto a detail of a plastic cage having the cage segments in FIG. 1 in a connecting region;

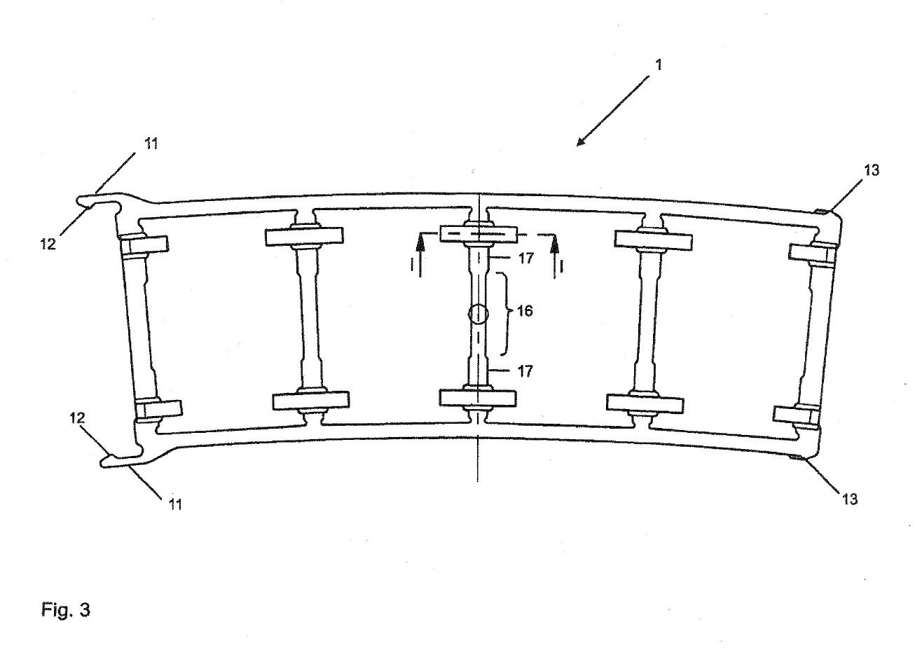

FIG. 3 shows a schematic, three-dimensional plan view from radially outside onto a cage segment of the plastic cage in FIG. 2;

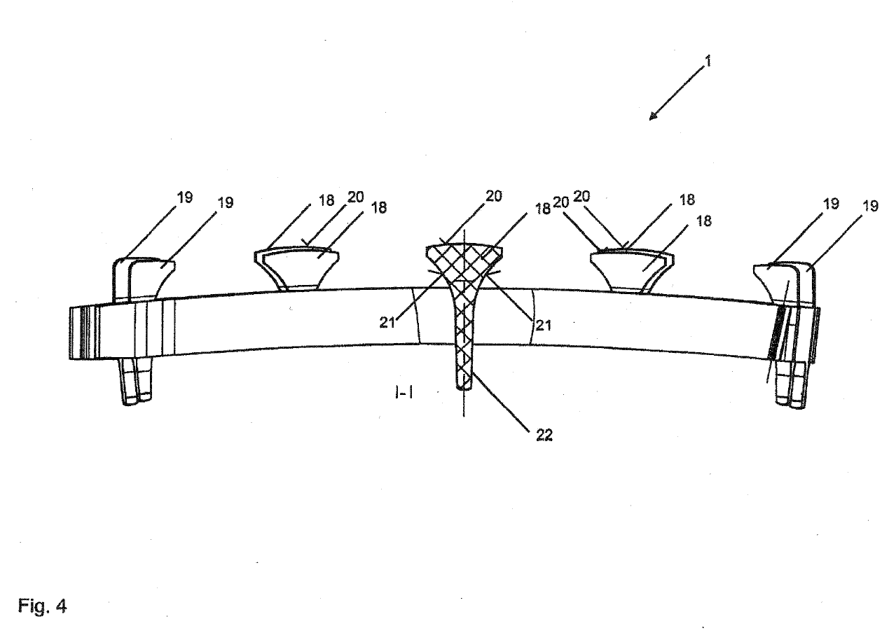

FIG. 4 shows a schematic, three-dimensional axial, partially sectional plan view along the sectional line I-I in FIG. 3 onto the cage segment from the previous figures;

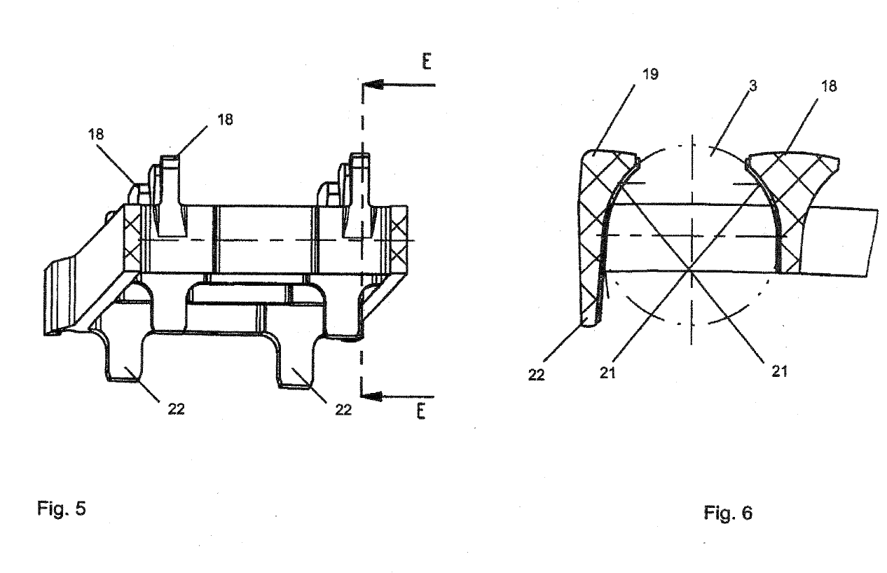

FIG. 5 shows a schematic, three-dimensional sectional view along the line B-B in FIG. 1; and

FIG. 6 shows a sectional illustration along the sectional line E-E in FIG. 5.

FIG. 1 shows a three-dimensional, schematic illustration of a cage segment 1 for a plastic cage 2 (FIG. 2) of a roller bearing which is embodied as a large-diameter roller bearing with a pitch diameter of greater than 500 mm, and is used, for example, for supporting rotors in wind power plants. In particular, the roller bearing is embodied without play and/or in a pre-stressed fashion. For example, the cage is formed from poly-ether-ether-ketone.

As is apparent, in particular, if said figure is considered together with FIG. 2, in each case similar cage segments 1 can be arranged adjoining or abutting against one another at their ends in the circumferential direction and hooked to one another in order to form a circumferential plastic cage 2 for the guidance of roller bearings 3 (FIG. 6). In the illustration of a detail shown in FIG. 2, the plastic cage 2 is shown in the region of a connecting point 4 at which two cage segments 1 are connected to one another in a releasable fashion.

Each cage segment 1 has two laterally running side ring sections 5 which are embodied as side bands and are connected to one another via transverse webs 6, with the result that pockets 7 for the roller bodies 3 (FIG. 6) are formed between the transverse webs 6. In the embodiment shown, each cage segment has four pockets 7 and five transverse webs 6.

In the end region of the cage segments 1, end sides 8 of the cage segments 1 are formed by the transverse webs 6, wherein the end sides 8 of adjacent cage segments 1 are arranged abutting and/or adjoining one another. To be more precise, the end sides 8 are not embodied so that they abut one another over their entire surface, but rather each have a bearing contour 9 in the edge regions, wherein a free gap 10, which can be used, for example, for lubricant flow-through, remains in the central region.

The connecting point 4 is produced by a connecting device which is formed from clips 11 with securing noses 12 on one of the cage segments 1 and opposing securing noses 13 on another cage segment 1. The clips 11 are arranged offset and parallel with respect to the side ring sections 5 in the axial direction and are connected integrally thereto at one end, wherein a ramp 14 is formed on the axial end side. The clips 11 engage from the axially outer side around the adjacent cage segment 1 and have the securing noses 12 at their elastic free ends, wherein the securing noses 12 of the two clips 11 are arranged facing one another.

The securing noses 12 engage in a securing fashion around the opposing securing noses 13, which are formed on in an end region of the side ring sections 5 of the adjacent cage segment 1. The clips 11, the position of the securing noses 12 and of the opposing securing noses 13, is embodied with respect to the end side 8, in particular in the region of the bearing contour 9, in such a way that the connecting point 4 in the hooked state has a limited play, arrow 15, with the result that the two adjacent cage segments 1 can move relative to one another in the circumferential direction within the scope of the limited play 15.

The limited play 15 is configured here in terms of its magnitude in such a way that it is sufficient to compensate longitudinal extensions of one of the cage segments 1 in the circumferential direction owing to thermal effects and/or swelling effects. Considered in functional terms, the play 15 is selected such that a change in length of one of the cage segments 1 when the temperature increases from, for example, 20° C. to, for example, at maximum 150° C. can be compensated. Defined in absolute terms, the limited play 15 is defined in the range between 0.2% and 2% of the circumferential length of one of the cage segments 1.

A further feature of the connecting point 4 is that it can be released without destruction when a certain limiting tensile force is exceeded. It is therefore possible that in the event of temporary overloading the plastic cage of the roller bearing opens in order to yield to this overloading. In the further operation, a compressive force which acts in the circumferential direction is sufficient to close the plastic cage again at the opened connecting point 4. For this purpose, the securing noses 12 and opposing securing noses 13 on the hooking edges in the illustration shown in FIG. 2 are embodied in a ramp-like fashion, with the result that they can slide over one another without destruction both when opening and closing occur.

FIG. 3 shows the cage segment 1 in a radial plan view from the inside, and it can be seen here that the opposing securing noses 13 are arranged on one free end of the cage segment 5, and the clips 11 are arranged on the other side of the cage segment. As is also very clear from this illustration, the transverse webs 6 are embodied so as to be tapered or wasted in cross section in the circumferential direction in a central part 16 which makes up between a third and half of the overall length of the transverse web 6. This central part 16 is, considered in functional terms, embodied in such a way that the roller bodies 3 are arranged or run without contact with the latter, wherein the roller bodies 3 are guided exclusively via edge regions 17. This embodiment has the advantage that in the central part 16 sufficient space remains for lubricant to pass through to the roller body 3, in particular no lubricant is wiped off at the transverse web 6 in the region of the central part 16.

FIG. 4 shows a schematic, axial plan view of the cage segment 5 with a partial section along the sectional line I-I in FIG. 3, wherein it is once more apparent that the side ring sections 5 and the clip 11 have the same or essentially the same extent in the radial direction.

In the radially outer direction, the cage segment 1 has sliding shoes 18, 19, wherein a pair of complete sliding shoes 18 are arranged on each of the inner transverse webs 6, and a pair of half sliding shoes 19 are positioned on the transverse webs 6 which are arranged on the end sides. The central sliding shoes 18 have, in a lateral plan view, a mushroom-like or funnel-like shape which comprises a bearing face 20, facing radially outward, for bearing on the external ring (not shown). The bearing face 20 is of curved design and bears with its center on the raceway of the external ring. The curvature radius of the bearing face in the lateral view shown in FIG. 4 is made significantly smaller than the curvature radius of the raceway of the external ring, wherein, in the cross section shown, triangular-like free spaces are formed between the bearing face 20 and the raceway of the external ring, with the result that lubricant is pushed under the sliding shoes 18 during operation.

In the circumferential direction, the sliding shoes 18, 19 have guide faces 21 on which the roller bodies 3 are guided (FIG. 6). The guidance of the cage segment 1 is therefore provided, on the one hand, by the bearing face 20 bearing on the raceway of the external ring and, on the other hand, by the guide face 21 bearing on the roller body 3.

In order to provide radial support on the inner side, the cage segment 5 has guide knobs 22 which are dimensioned in their radial length in such a way that, in a normal operating mode of the roller bearing, they are arranged spaced apart from the raceway of the internal ring. The guide knobs 22 rest on the internal ring only if very severe deformations of the roller bearing occur, for example in the event of severe stressing or in the event of wear occurring to the sliding shoes 18, 19 in the region of the guide faces 21 or of the bearing faces 20. So that the sliding friction is also minimized there, the free end regions of the guide knobs 22 are of rounded design. The guide knobs 22 are formed only on the outer and central transverse webs 6, viewed in the circumferential direction. The transverse webs 6 lying between them do not have any guide knobs.

FIG. 5 shows the cage segment 1 in a schematic, three-dimensional illustration obliquely from radially inside. With respect to this illustration, it is necessary to explain that the sliding shoes 18, 19 are arranged at the edge side in the axial direction and are given a narrow dimension in the axial extent in such a way that they are arranged outside an axial region in which the compression ellipse between the roller body 3 and the raceway of the external ring is usually produced during operation. This lateral positioning in turn improves the lubrication of the roller bodies 3, since wiping-off effects by the sliding shoes 18 and 19 in the loaded region of the roller bodies 3 are minimized. The guide knobs 22 have a rectangular base shape in the view shown.

FIG. 6 shows a section in the circumferential direction of rotation along the sectional line E-E in FIG. 5, where it is shown that the roller body 3 which is embodied as a tapered roller fits closely against the guide faces 21 of the sliding shoes 18 and 19 radially on the inner side and is guided by them.

### LIST OF REFERENCE NUMERALS

1 Cage segment
2 Plastic cage
3 Roller body
4 Connection
5 Side ring section
6 Transverse web
7 Pocket
8 End sides
9 Bearing contour
10 Gap
11 Clip
12 Securing nose
13 Opposing securing nose
14 Ramp
15 Play
16 Central part
17 End region
18 (Full) sliding shoe
19 (Half) sliding shoe
20 Bearing face
21 Guide face
22 Guide knob

1. A cage segment of a plastic cage for large-diameter roller bearing,
wherein a plurality of the cage segments for forming the plastic cage are arranged and/or are to be arranged adjoining and/or abutting one another at their ends in a circumferential direction,
comprising:
at least one pocket for a roller body; and
a connecting device which is embodied in such a way that the cage segments can be connected to one another in a chain.

2. The cage segment of claim 1, wherein connecting device is designed to permit limited play between the cage segments in a circumferential direction in the plastic cage.

3. The cage segment of claim 2, wherein the limited play is of a magnitude in a region of maximum thermal expansion and/or swelling expansion of one of the segments.

4. The cage segment of claim 1, further comprising transverse webs and side ring sections, wherein the transverse webs connect the side ring section with a result that an intermediate space between the transverse webs forms the at least one pockets.

5. The cage segment of claim 4, wherein the transverse webs are embodied in such a way that only certain sections, in particular only the end regions, of the roller bodies come to bear in a longitudinal direction against the transverse webs.

6. The cage segment of claim 5, wherein the transverse webs are embodied with a reduced diameter and/or wasted in a central part of the transverse webs in a circumferential direction of the plastic cage.

7. The cage segment of claim 4, wherein the connecting device comprises clips which are arranged offset in an axial direction parallel to the side ring sections and formed integrally thereon.

8. The cage segment of claim 7, wherein one, some or all of the clips has/have a securing nose which is directed axially with respect to an internal region of the cage segment.

9. The cage segment of claim 1, wherein the connecting device comprises opposing securing noses which are arranged on an axial external side of the cage segment.

10. The cage segment of claim 9, wherein the connecting device is embodied in such a way that the securing noses of a first cage segment hook together with the opposing securing noses of a second cage segment in order to form a section of the plastic cage.

11. The cage segment of claim 4, wherein at least one sliding shoe, which is designed to be supported in a sliding fashion on a bearing ring, is formed on the cage segment, in particular on at least one of the transverse webs.

12. The cage segment of claim 11, wherein the sliding shoe assumes, in an axial plan view, a shape of a filled funnel or of a mushroom and/or is designed for the sliding shoe to be supported centrally on the bearing ring.

13. The cage segment of claim 4, wherein two sliding shoes, which are spaced apart from one another in an axial direction, are formed on the transverse web.

14. The cage segment of claim 11 to 13, wherein a side face, facing an adjacent roller body, of the sliding shoe, is embodied as a guide face for the roller body.

15. The cage segment of claim 1, further comprising at least one guide knob which is designed to support the cage segment on a further bearing ring.

16. The cage segment of claim 15, wherein the guide knob has, at a free end, features which reduce sliding friction, in particular a rounded portion.

17. The cage segment of claim 1, wherein the cage segment is formed from PEEK material.

18. A roller bearing, comprising:
a plastic cage, wherein the plastic cage is formed from a plurality of the cage segments as claimed in one of claim 1.

19. The roller bearing of claim 18, wherein the cage segments are guided, on one hand, by means of the support via sliding shoes on an external ring and, on the other hand, via the bearing of guide faces against the roller bodies.
